(19) United States
(12) Patent Application Publication
(10) Pub. No.: US 2009/0323216 A1
(43) Pub. Date: Dec. 31, 2009

(54) STORAGE APPARATUS AND STORAGE MEDIUM

(75) Inventor: Takehiro Ishiguro, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/392,865

(22) Filed: Feb. 25, 2009

(30) Foreign Application Priority Data
Jun. 30, 2008 (JP) 2008-169954

(51) Int. Cl. G11B 21/02

(52) U.S. Cl. 360/75; G9B/21.003

(57) ABSTRACT

A storage apparatus includes: a magnetic recording disk having discrete magnetic dots forming circular tracks coaxial with a rotation axis; a rotary actuator supporting a head slider facing the magnetic recording disk, the rotary actuator coupled to a pivot bearing shaft parallel to the rotation axis; and read and write elements separately-located at a gap distance on a given straight line. A distance between two circular tracks depends on the gap distance and the angle between one circular track of the two circular tracks and the given straight line.

### CROSS-REFERENCE TO RELATED APPLICATION

This application is based upon and claims the benefit of priority from the prior Japanese Patent Application No. 2008-169954 filed on Jun. 30, 2008, the entire contents of which are incorporated herein by reference.

### FIELD

The embodiment discussed herein is related to a storage apparatus such as a hard disk drive.

### BACKGROUND

A so-called patterned medium is well known. The patterned medium includes a substrate formed in the shape of a disk. Discrete magnetic dots are arranged on the surface of the substrate so as to form circular tracks coaxial with the center axis of the disk.

Since the discrete magnetic dots are isolated from one another along the circular tracks in the patterned medium, the writing operation is synchronized with the arrangement of the discrete magnetic dots for writing data on the patterned medium. The write clock is needed to synchronize the actions of a write operation.

### SUMMARY

According to an aspect of the invention, a storage apparatus includes: a magnetic recording disk having discrete magnetic dots forming circular tracks; a rotary actuator supporting a head slider facing the surface of the magnetic recording disk, the rotary actuator rotating about a pivot bearing shaft to move the head slider; and read and write elements located on the surface of the head slider, separated by a gap and facing the magnetic recoding disk. A distance between two circular tracks depends on the gap distance and the angle between one circular track of the two circular tracks and the straight line joining the read element and the write element.

The object and advantages of the embodiment will be realized and attained by means of the elements and combinations particularly pointed out in the appended claims. It is to be understood that both the foregoing general description and the following detailed description are exemplary and explanatory and are not restrictive of the embodiment, as claimed.

### BRIEF DESCRIPTION OF THE DRAWINGS

FIG. 1 is a plan view schematically illustrating a hard disk drive according to an embodiment of the present invention;

FIG. 2 is an enlarged perspective view schematically illustrating a flying head slider according to an example of the present invention;

FIG. 3 is a front view schematically illustrating an electromagnetic transducer observed from a medium-opposed surface;

FIG. 4 is a sectional view taken along the line 4-4 in FIG. 3;

FIG. 5 is an enlarged partial front view of the electromagnetic transducer;

FIG. 6 is an enlarged partial plan view schematically illustrating the arrangement of magnetic dots;

FIG. 7 is an exemplary diagram schematically illustrating a distance between a reproducing track and a recording track; and

FIG. 8 is an exemplary diagram schematically illustrating a distance between a reproducing track and a recording track.

### DESCRIPTION OF EMBODIMENT

An embodiment of the present invention will be explained below with reference to the accompanying drawings.

FIG. 1 schematically illustrates the inner structure of a hard disk drive, HDD, 11 as an example of a storage medium drive or storage apparatus. The hard disk drive 11 includes an enclosure 12. The enclosure 12 includes an enclosure cover, not illustrated, and a box-shaped enclosure base 13 defining an inner space in the shape of a flat parallelepiped, for example. The enclosure base 13 may be made of a metallic material such as aluminum, for example. Molding process may be employed to form the enclosure base 13. The enclosure cover is coupled to the enclosure base 13. The enclosure cover closes the opening of the enclosure base 13. Pressing process may be employed to form the enclosure cover out of a plate material, for example.

At least one magnetic recording disk 14 as a storage medium is placed in the inner space of the enclosure base 13. The magnetic recording disk or disks 14 are mounted on the driving shaft of a spindle motor 15. The spindle motor 15 drives the magnetic recording disk or disks 14 at a higher revolution speed such as 3,600 rpm, 4,200 rpm, 5,400 rpm, 7,200 rpm, 10,000 rpm, 15,000 rmp, or the like. The magnetic recording disk 14 has recording tracks on its surface, as described later in detail. The recording tracks are arranged in a concentric pattern. The recording tracks are divided into groups, namely recording track sets 16a, 16b, . . . . Each of the recording track sets 16a, 16b, . . . has two or more recording tracks. For example, the magnetic recording disk 14 has about twenty of the recording track sets 16a, 16b, . . . . Each of the recording track sets 16a, 16b, . . . has a constant data rate.

A carriage 17 is also placed in the inner space of the enclosure base 13. The carriage 17 includes a carriage block 18. The carriage block 18 is supported on the pivot bearing shaft 19 and rotates on the axis of the pivot bearing shaft 19. The pivot bearing shaft 19 is parallel to the axis of the driving shaft of the spindle motor 15. Carriage block 18 has carriage arms 21. The carriage 17 has carriage arms 21 rotatably mounted adjacent the magnetic recording disk 14. The carriage block 18 may be made of aluminum, for example. Extrusion process may be employed to form the carriage block 18, for example.

A head suspension 22 is attached to the front or tip end of the carriage arm 21. A flexure is attached to the head suspension 22. The flexure has a gimbal at the front or tip end of the head suspension 22. A magnetic head slider, namely a flying head slider 23, is supported on the gimbal. The gimbal allows the flying head slider 23 to change its attitude relative to the head suspension 22. A head element, namely an electromagnetic transducer, is mounted on the flying head slider 23. The carriage 17 and the head suspensions 22 in combination serve as a swinging body according to an example of the present invention.

When the magnetic recording disk 14 rotates, the flying head slider 23 is received airflow generated along the rotating magnetic recording disk 14. The airflow generates a positive pressure and a negative pressure on the flying head slider 23. The head slider 23 is supported by an air bearing formed between the disk surface and the head slider surface. The flying head slider 23 is in this manner flies above the surface of the magnetic recording disk 14 during the rotation of the magnetic recording disk 14 at a higher stability.

A power source such as a voice coil motor, VCM, 24 is coupled to the carriage block 18. The voice coil motor 24 drives the carriage block 18 around the pivot bearing shaft 19. The carriage block 18 rotates and the carriage arm 21 positions the head slider 23 over the magnetic recording disk 14 while the disk is spinning. Thus, the electromagnetic transducer on the flying head slider 23 is crossed the data zone defined between the innermost and outermost recording tracks. The electromagnetic transducer on the flying head slider 23 is positioned right above a target recording track on the magnetic recording disk 14.

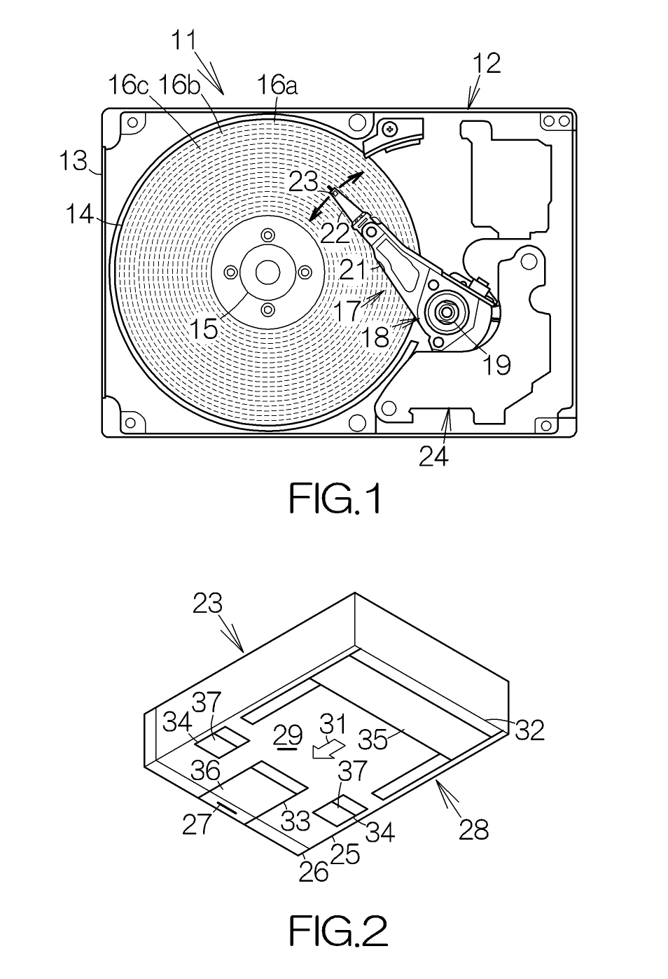

FIG. 2 illustrates one example of the flying head slider 23. The flying head slider 23 includes a base or a slider body 25 in the form of a flat parallelepiped, for example. An insulating non-magnetic film, namely a head protection film 26, is overlaid on the outflow or trailing edge surface of the slider body 25. The electromagnetic transducer 27 is incorporated in the head protection film 26. The electromagnetic transducer 27 will be described later in detail.

The slider body 25 is made of a hard material such as Al₂O₃—TiC. The head protection film 26 is made of a relatively soft material such as Al₂O₃ (alumina). A medium-opposed surface, namely a bottom surface 28, faces the magnetic recording disk 14 at a distance. A flat base surface 29 as a reference surface is formed on the bottom surface 28. When the magnetic recording disk 14 is rotating, airflow 31 flows along the bottom surface 28 from the inflow or front end to the outflow or rear end of the slider body 25.

A front rail 32 is formed on the bottom surface 28 of the slider body 25. The front rail 32 stands upright from the base surface 29 of the bottom surface 28 near the leading edge of the slider body 25. The front rail 32 extends along the inflow edge of the base surface 29 in the lateral direction of the slider body 25. A rear center rail 33 is likewise formed on the bottom surface 28 of the slider body 25. The rear center rail 33 stands upright from the base surface 29 of the bottom surface 28 near the trailing edge of the slider body 25. The rear center rail 33 is located at the intermediate position in the lateral direction of the slider body 25. The rear center rail 33 extends to reach the head protection film 26. A pair of rear side rails 34, 34 are likewise formed on the bottom surface 28 of the slider body 25. The rear side rails 34, 34 stand upright from the base surface 29 of the bottom surface 28 near the trailing edge of the slider body 25. The rear side rails 34, 34 are located along the sides of the slider body 25, respectively. The rear center rail 33 is located in a space between the rear side rails 34, 34.

Air bearing surfaces 35, 36, 37, 37 are formed on the top surfaces of the front rail 32, the rear center rail 33 and the rear side rails 34, 34, respectively. Steps is formed to connect the inflow edge of the air bearing surfaces 35, 36, 37 to the top surfaces of the front rail 32, the rear center rail 33 and the rear side rails 34, respectively. When the bottom surface 28 of the flying head slider 23 receives the airflow 31, the steps generate a relatively larger positive pressure or lift force at the air bearing surfaces 35, 36, 37, respectively. Additionally, a larger negative pressure is generated behind the front rail 32 or at a position downstream of the front rail 32. The negative pressure is balanced with the lift force so as to support the flying attitude of the flying head slider 23. As a matter of course, the flying head slider 23 can take any other shape or form different from the aforementioned one.

The electromagnetic transducer 27 is located in the rear center rail 33 at a downstream position of the air bearing surface 36. The electromagnetic transducer 27 includes a read element and a write element, for example. A tunnel-junction magnetoresistive (TMR) element is employed as the read element. The electric resistance of the read head is changed in response to the inversion of the magnetic field from the magnetic recording disk 14. The read element reads binary data by detecting this magneto resistance change. A so-called single pole head is employed as the write element. A thin film coil pattern of this single pole head generates a magnetic field. The single pole head writes data into magnetic recording disk 14 by generating magnetic field. The electromagnetic transducer has the read gap of the read element and the write gap of the write element to get exposed at the surface of the head protection film 26. A hard protection film may be formed on the surface of the head protection film 26 at a position downstream of the air bearing surface 36. Such a hard protection film covers over the write gap and the read gap exposed at the surface of the head protection film 26. The protection film may be made of a DLC (Diamond like Carbon) film, for example.

As depicted in FIG. 3, the read element 42 includes a tunnel-junction magnetoresistive film 45 sandwiched between a pair of electrically-conductive layers, namely a lower electrode layer 43 and an upper electrode layer 44. The lower electrode layer 43 and the upper electrode layer 44 extend along parallel planes, respectively, perpendicular to a virtual plane PL including the axis of the pivot bearing shaft 19. The lower electrode layer 43 and the upper electrode layer 44 may be made of a material having a high magnetic permeability such as FeN, NiFe, or the like. The thicknesses of the lower electrode layer 43 and the upper electrode layer 44 are set in a range of 2.0 μm to 3.0 μm, for example. The lower electrode layer 43 and the upper electrode layer 44 work as a lower shielding layer and an upper shielding layer, respectively.

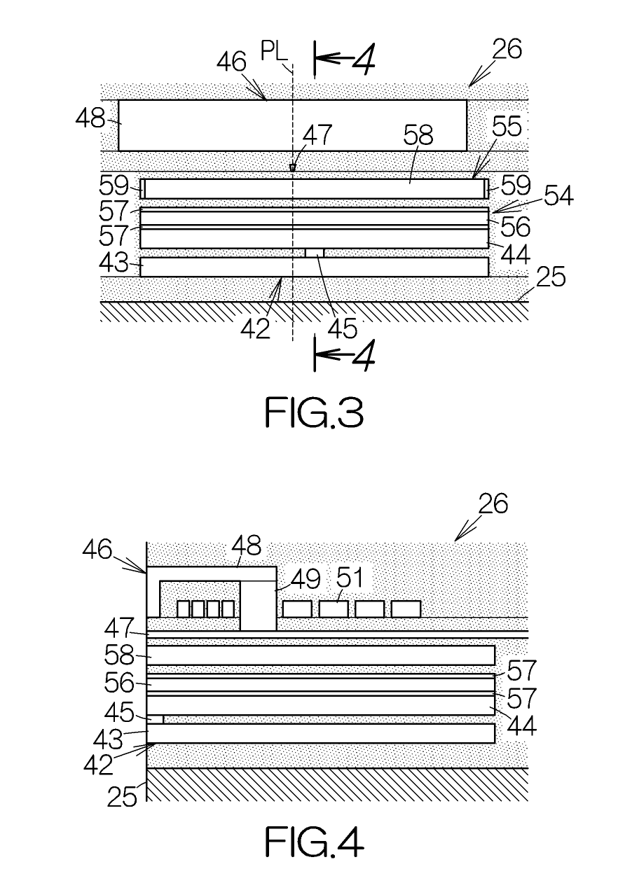

The write element 46, namely the single pole head, includes a main magnetic pole 47 and an auxiliary magnetic pole 48, exposed on the surface of the rear center rail 33. The main magnetic pole 47 and the auxiliary magnetic pole 48 may be made of a magnetic material such as FeN, NiFe, or the like. Referring also to FIG. 4, a magnetic connecting piece 49 connects the rear end of the auxiliary magnetic pole 48 to the main magnetic pole 47. A magnetic coil, namely a thin film coil pattern 51, is formed in a swirly pattern around the magnetic connecting piece 49. The main magnetic pole 47 works as a magnetic core which is penetrating through the center of the thin film coil pattern 51 in combination with the auxiliary magnetic pole 48 and the magnetic connecting piece 49.

A first deformable element 54 and a second deformable element 55 are located between the read element 42 and the write element 46. The first deformable element 54 includes a piezoelectric ceramics layer 56 extending along a plane perpendicular to the virtual plane PL. The piezoelectric ceramic layer 56 is polarized in a direction parallel to the virtual plane PL. The piezoelectric ceramics layer 56 is sandwiched between upper and lower electrode layers 57, 57. Voltage is applied through the upper and lower electrode layers 57, 57 in parallel with the virtual plane PL. The thickness of piezoelectric ceramic layer 56 is changed by applying voltage. The second deformable element 55 includes a piezoelectric ceramics layer 58 extending along a plane perpendicular to the virtual plane PL. The piezoelectric ceramic layer 58 is polarized in a direction perpendicular to the virtual plane PL. The piezoelectric ceramics layer 58 is sandwiched between electrode pieces 59, 59. Voltage is applied through the electrode pieces 59 in parallel with a plane perpendicular to the virtual plane PL. The piezoelectric ceramic layer 58 is sheared by applying voltage.

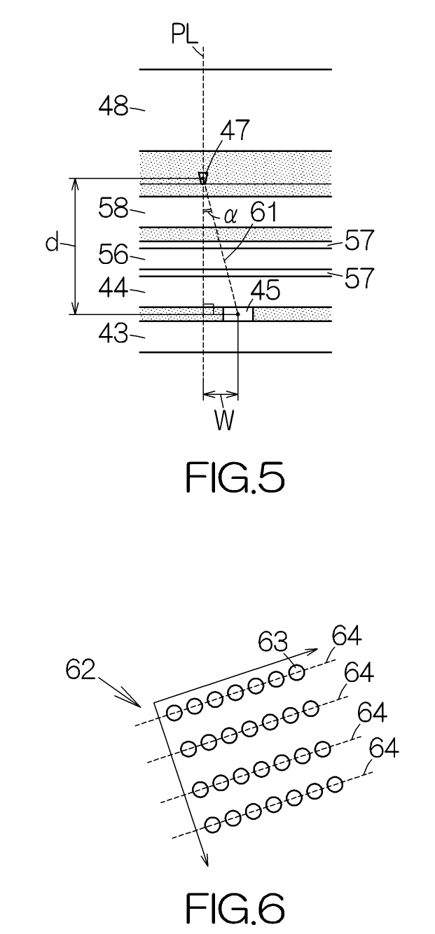

As depicted in FIG. 5, the electromagnetic transducer 27 has a angle α between the virtual plane PL and a straight line 61 connecting the tunnel-junction magnetoresistive film 45 to the main magnetic pole 47. In this case, “d” denotes a distance measured in the radial direction in parallel with the virtual plane PL between the exposed surface of the tunnel-junction magnetoresistive film 45 and the exposed surface of the main magnetic pole 47. Likewise, “w” denotes a distance measured in the circumferential direction in parallel with a plane perpendicular to the virtual plane PL between the exposed surface of the tunnel-junction magnetoresistive film 45 and the exposed surface of the main magnetic pole 47. Hence, a distance between the exposed surface of the tunnel-junction magnetoresistive film 45 and the exposed surface of the main magnetic pole 47 is expressed as the square root of (d²+w²). A change in the thickness of the piezoelectric ceramics layer 56 of the first deformable element 54 leads to a change in the distance d in the radial direction. The shearing deformation of the piezoelectric ceramics layer 56 of the second deformable element 55 leads to a change in the distance w in the circumferential direction.

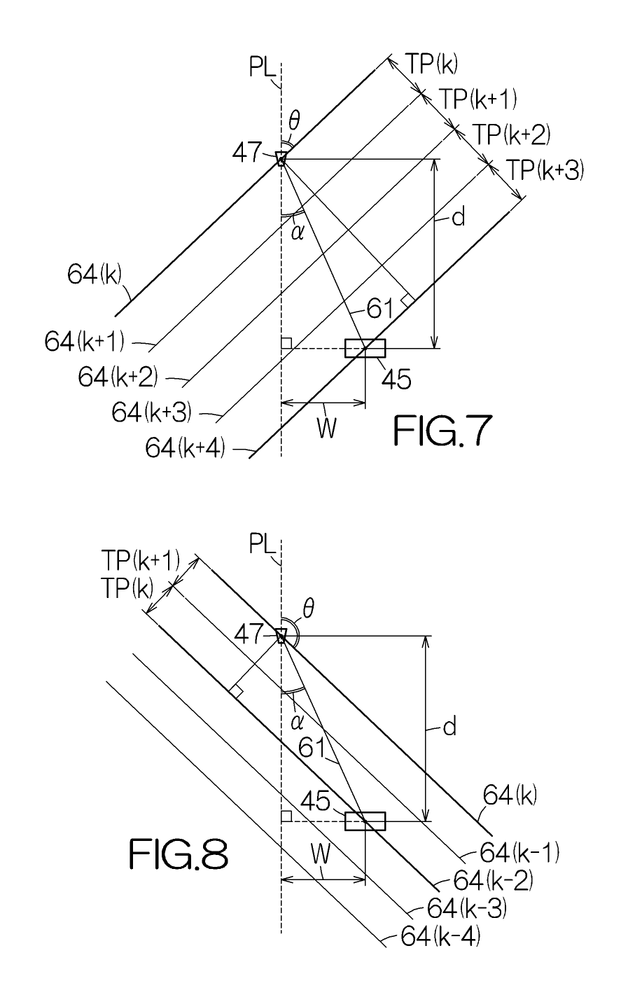

As depicted in FIG. 6, the magnetic recording disk 14 includes a disk-shaped substrate 62. The magnetic dots 63 are arranged discretely on the surface of the disk-shaped substrate 62 and form circular tracks 64 coaxial with the center axis of the magnetic recording disk 14. In other words, the magnetic dots 63 are isolated from one another in the every circular track 64. A data rate is constant in each of the recording track sets 16a, 16b, . . . . Here, as depicted in FIG. 7, a distance between a k-th recording track 64(k) which the write element follows and a (k+4)-th recording track 64(k+4) which the read element follows, which depends on track pitches TP between the k-th recording track 64(k) and the (k+4)-th recording track 64(k+4), is defined by Equation 1. In FIG. 7, the write elements following the recording track 64(K) is located closer to the inner circumference of the magnetic recording disk 14 than the read element following the recording track 64(k+4).

$$\sqrt{{d}^{2} + {w}^{2}} cos ( \frac{π}{2} - θ ( k ) - {tan}^{- 1} ( \frac{w}{d} ) ) = {\sum }_{i = k}^{k + N - 1} TP ( i ) \qquad [ Equation 1 ]$$

Here, θ(k) is an angle between the virtual plane PL and the k-th recording track 64(k) which the main magnetic pole 47 follows. The angle θ(k) depends on a distance between the pivot bearing shaft 19 and the main magnetic pole 47, the radius of the k-th recording track 64(k), and a distance between the axis of the driving shaft of the spindle motor 15 and the axis of the pivot bearing shaft 19. It should be noted that the individual track pitch TP(i) is equal to or larger than the minimum track pitch TP on the magnetic recording disk 14. Likewise, as depicted in FIG. 8, a distance between a k-th recording track 64(k) and a (k−2)-th recording track 64(k−2) is defined by Equation 1 described above. In FIG. 8, the write elements following the recording track 64(K) is located closer to the outer circumference of the magnetic recording disk 14 than the read element following the recording track 64(k−2).

Now, assume that binary data is written into any one of the recording tracks. The tunnel-junction magnetoresistive film 45 is positioned on a predetermined recording track 64(k). Data is read out from the magnetic dots 63 on the predetermined recording track 64(k). The amplitude of the output is detected. Tracking servo is executed in accordance with the detected amplitude. The tunnel-junction magnetoresistive film 45 keeps tracking a predetermined recording track 64(k). In this case, the main magnetic pole 47 keeps tracking a target recording track 64(k+N). There is/are N track pitch/pitches TP between the target recording track 64(k+N) and the predetermined recording track 64(k). In this manner the predetermined recording track 64(k) is not necessarily located adjacent to the target recording track (k+N). It is acceptable that the target recording track 64(k+N) and the predetermined recording track 64(k) are same track. In other words, N is zero in this case. It should be noted that the predetermined reproducing track 64(k) and the target recording track 64(k+N) preferably belong to the same recording track set, that is, one of the recording track sets 16a, 16b, . . . .

The tunnel-junction magnetoresistive film 45 receives a magnetic field from the magnetic dots 63. Since the magnetic dots 63 are arranged on the recording track at constant intervals, the output signal has a frequency depending on this interval. The output signal is utilized to generate a writing clock signal. The main magnetic pole 47 generates a recording magnetic field magnetizing the magnetic dots 63 on the recording track based on the generated write clock signal. In this manner, the write element 46 performs reliably a writing operation on the magnetic dots 63. Data are reliably written on the magnetic recording disk 14.

A non-magnetic film, namely an aluminum film, is formed on the surface of the disk-shaped substrate 62 for the production of the magnetic recording disk 14. The aluminum film is formed by an anodic oxidation or anodization process as well known to those skilled in the art. The anodic oxidation process forms regularly-arranged nanoholes on the surface of the disk-shaped substrate 62. The nanoholes are arranged on every circular track in such a way that the data rates of the recording tracks are constant in the same recording track set. The aforementioned distance d in the radial direction and the aforementioned distance w in the circumferential direction are set in accordance with the designed value of the electromagnetic transducer 27 for determination of a track pitch TP. An angle θ is set between the virtual plane PL and a circular track, which is located at a certain radial distance, based on the designed value of a distance between the pivot bearing shaft 19 and the main magnetic pole 47 and the designed value of a distance between the axis of the driving shaft of the spindle motor 15 and the axis of the pivot bearing shaft 19.

Now, assume that a production error happens to the tunnel-junction magnetoresistive film 45 and the main magnetic pole 47 on the flying head slider 23. The distance d in the radial direction and the distance w in the circumferential direction deviate from their respective designed values in the flying head slider 23. A controlling current is supplied to the first deformable element 54 and/or the second deformable element 55 in accordance with the deviation. This operation changes the thickness of the piezoelectric ceramics layer 56 and causes the shearing deformation of the piezoelectric ceramics layer 58. In this manner, the distance d in the radial direction and/or the distance w in the circumferential direction can be modified. When the tunnel-junction magnetoresistive film 45 tracks a predetermined recording track, the main magnetic pole 47 also tracks a target recording track.

All examples and conditional language recited herein are intended for pedagogical purposes to aid the reader in understanding the invention and the concept contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A storage apparatus comprising:
a magnetic recording disk having discrete magnetic dots forming circular tracks coaxial with a rotation axis;
a rotary actuator supporting a head slider facing to the magnetic recording disk, the rotary actuator coupled to a pivot bearing shaft parallel to the rotation axis; and
read and write elements separately-located at a gap distance on a given straight line,
wherein a distance between two circular tracks depends on the gap distance and an angle between one circular track of the two circular tracks and the given straight line.

2. The storage apparatus according to claim 1, wherein a following equation is effected:
$$\sqrt{{d}^{2} + {w}^{2}} cos ( \frac{π}{2} - θ ( k ) - {tan}^{- 1} ( \frac{w}{d} ) ) = {\sum }_{i = k}^{k + N - 1} TP ( i )$$
wherein d is a distance between the read and write elements in a radial direction in parallel with an virtual plane including the pivot bearing shaft and the write element, w is a distance between the read and write elements in a circumferential direction in parallel with a plane perpendicular to the virtual plane, θ(k) is the angle between a k-th circular track (k) and the virtual plane, and TP is a track pitch; and the right-hand side shows a summation of track pitches between the k-th circular track (k) and a (k+N)th circular track (k+N).

3. The storage apparatus according to claim 1, wherein a deformable element is provided between the read and write elements, the deformable element configured to change the distance w which is between the read and write elements and in the circumferential direction in parallel with a plane perpendicular to the virtual plane including the pivot bearing shaft and the write element.

4. The storage apparatus according to claim 1, wherein a deformable element is provided between the read and write elements, the deformable element configured to change the distance d which is between the read and write elements and in the radial direction in parallel with the virtual plane including the pivot bearing shaft.

5. A storage medium comprising:
a disk-shaped substrate; and
discrete magnetic dots forming circular tracks coaxial with a center axis of the disk-shaped substrate on a surface of the disk-shaped substrate,
wherein a distance between two circular tracks depends on a gap distance and an angle, the gap distance between read and write elements facing to the surface of the disk-shaped substrate, the angle between one circular track of the two circular tracks and a straight line connecting the read and write elements to each other.
